(19) United States
(12) Patent Application Publication
(10) Pub. No.: US 2007/0226184 A1
(43) Pub. Date: Sep. 27, 2007

(54) Decision support system for CBRNE sensors

(76) Inventors: Sam J. Diraimondo, Cary, IL (US); Robert A. Biggs, Evanston, IL (US); Meenakshi Prasad, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/387,398

(22) Filed: Mar. 23, 2006

(51) Int. Cl. G06F 17/30

(52) U.S. Cl. 707/3

(57) ABSTRACT

A decision support system (DSS) operates to generate a contact list of members of a media share group who are to be contacted when a sensor alarm signals the occurrence of an event, such as a chemical, biological, radiological, nuclear or explosive (CBRNE) event. The list generation begins when a sensor alarm report is received from a sensor data controller, processing the sensor alarm report and accessing at least one data source of the plurality of data sources, dependent upon the sensor alarm report, to obtain accessed data. The contact list, which is dependent upon the accessed data, is output to a media share controller to control media signals, such as text, graphics, audio and/or video signals, between members of the media share group.

### BACKGROUND

Public safety agencies seek to provide quick and efficient responses to events or incidents, such as terrorist attacks or major accidents, in high risk areas. These events can be chemical, biological, radiological, nuclear or explosive (CBRNE) in nature. Examples of high risk areas include government buildings, high rise buildings, utility plants, mass transit terminals and water treatment centers. Incidents in these areas can impact large populations and an efficient response is often critical to saving lives.

Much of the data needed to validate and act upon these incidents are in detached databases owned and operated by separate government or public safety agencies. The time spent retrieving this data in the early stages of the decision making process delays the response.

Currently, CBRNE sensors are used collect data from target areas and to supply that data to a single responder agency. A single-agency decision support system (DSS) may be used to help with the task of collecting and analyzing the data from the sensors and directing protective actions. A network gathers sensor and/or video data in real-time from various detection probes and transmits the data over a robust wireless connection. The information is then compiled and correlated through a data engine, and provides a visual representation through a software client.

Many incidents require responses from multiple responder agencies. A single-agency decision support system does not help to select and coordinate responders.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a block diagram of a decision support system for CBRNE sensors consistent with certain embodiments of the invention.

FIGS. 2-4 are flow charts of a method consistent with certain embodiments of the invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

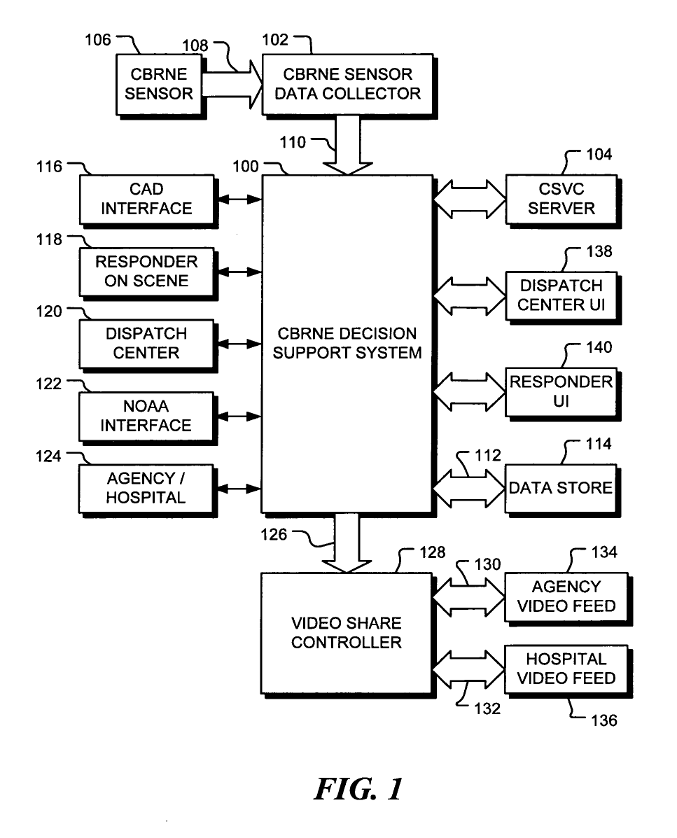

FIG. 1 is a block diagram of a decision support system (DSS) for CBRNE sensors consistent with certain embodiments of the invention. The decision support system (DSS) 100 collects and processes information and compiles a media feed group that is best suited to handle an incident. The media may be audio, video, text, graphics or any combination thereof. In particular, the DSS is used to establish connections to a chemical, biological, radiological, nuclear or explosive (CBRNE) sensor data collector 102 and a camera steering video capture (CSVC) server 104. CBRNE sensors 106 provide CRNE data 108 to the CBRNE sensor data collector 102. The sensors are typically placed in high risk areas and pass sensor data and identification data to the collector 102. The collector 102 validates the sensor and the event data and compiles an alarm report. When a CBRNE event is detected, the corresponding alarm report 110 is passed from the CBRNE sensor data collector 102 to the decision support system (DSS) 100. The DSS 100 processes the alarm report 110 to extract necessary information. From this information, a CBRNE event record 112 is generated and stored in a persistent data store 114. The DSS 100 can also connect to other information sources, such as a computer aided dispatch (CAD) system 116, a first responder device 118, a dispatch center 120, and the National Oceanic Atmospheric Administration (NOAA) weather center 122. These connections may be used to query the data sources and obtain information to store as part of the CBRNE event record 112.

The alarm report 110 contains location information (such as an identifier for fixed a sensor or a global position system (GPS) reading for mobile sensor). The DSS 100 uses this information to generate a contact list 126 of relevant agencies and medical facilities. The contact list identifies those persons or agencies that should be contacted when an event of the current type is triggered in a specific location. The agencies may be, for example, government agencies (federal, state or local) or private agencies. The contact list 126 is output to a media share controller 128, such as a video share controller as illustrated in the figure. The media share controller 128 uses the contact list to set up a media share group. In the exemplary embodiment shown in the figure, the media share controller 128 controls video signals 130 and 132 from an agency video feed 134 and a hospital video feed 136, allowing the video images and audio to be viewed by members of the media share group.

The location data is also used to allow the DSS 100 to connect any available video cameras in proximity to the CBRNE event via the camera steering video capture (CSVC) server 104. The camera may be installed close to the site of the event or may be a camera brought to the location by a first responder. The camera records video (or still) images at the site of the event. The corresponding video files are stored as part of the event record.

The DSS 100 may also provide a user interface 138 to personnel at a dispatch center and a user interface 140 to a first responder. These user interfaces

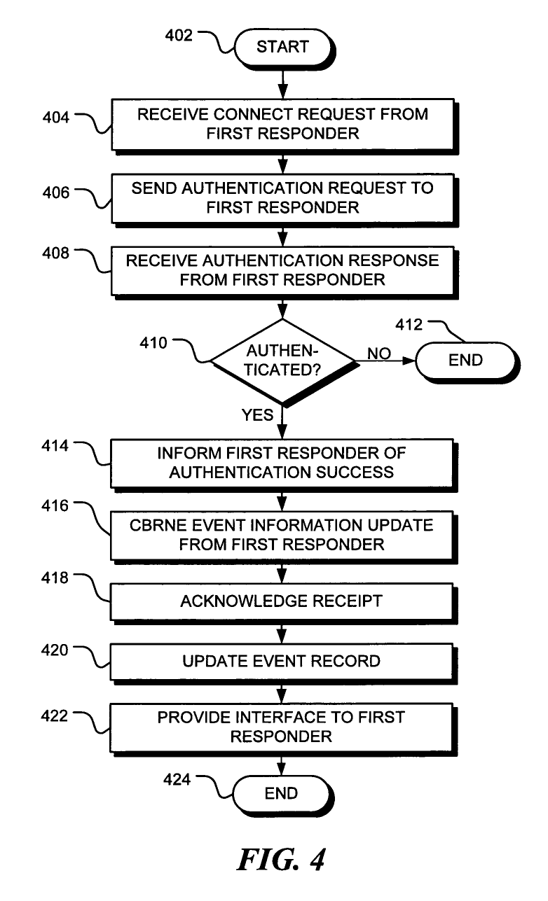

allow users to supply additional information concerning the event or to retrieve information from the DSS concerning the event. A user interface for a first responder is described in more detail below with reference to FIG. 4. A user interface to personnel at a dispatch center operates in a similar fashion.

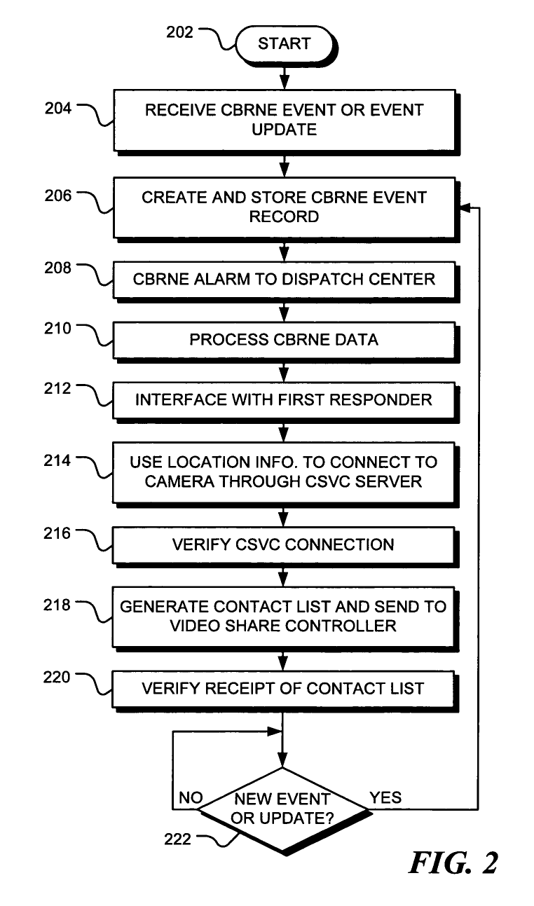

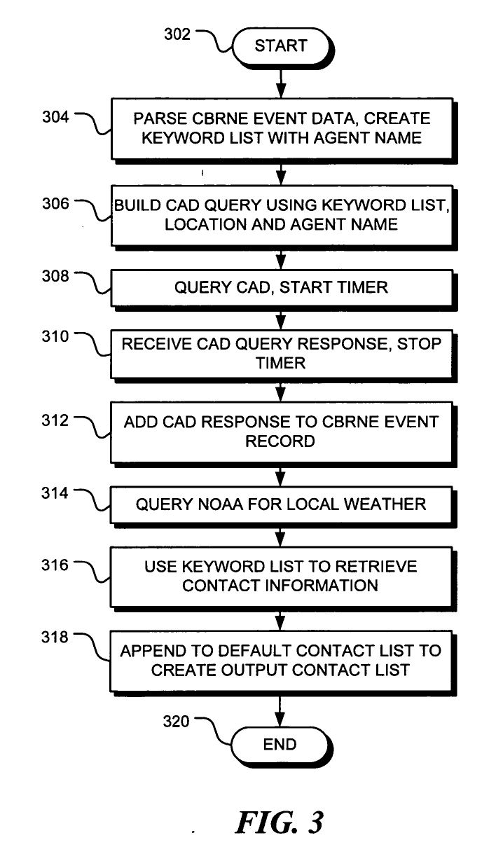

FIG. 2 is a flow chart of a method consistent with certain embodiments. Following start block 202 in FIG. 2, the decision support system (DSS) receives, at block 204, an input in the form of an alarm report from a CBRNE sensor data collector or an event update from a first responder or dispatch center. At block 206 the DSS creates a CBRNE event record using information from the alarm report together with information from other sources (such as local or remote databases). The CBRNE event record, which may include an event identifier and a time stamp, is stored in a persistent data store. At block 208 a CBRNE alarm is sent to the dispatch center so that a first responder can be dispatched to the site of the alarm. The DSS may provide a user interface to the dispatch center to support user interaction. At block 210, the DSS processes the CBRNE event data. This processing is discussed below with reference to FIG. 3. At block 212 an interface with the first responder is activated. This is discussed below with reference to FIG. 4. The interface allows the first responder to enter information into a communication device, such as broadband network enabled PDA. For example, the sighting of blue smoke coming from a canister may be noted. This information is used by the DSS to query a hazardous materials database, and the findings are sent back to the first responder and added to the event record. At block 214 location information from the CBRNE trigger event data, such as GPS position, is used to connect the DSS to an appropriate camera using the CSVC server. The connection to the CSVC server is verified at block 216. In one

embodiment, the DSS waits for a response, such as an acknowledgement, from the CSVC server. At block 218, a contact list is generated and sent to a media share controller. Optionally, at block 220, the DSS verifies the receipt of the contact list by the media share controller. In one embodiment, an acknowledgment is received from the media share controller if the contact list is received. At decision block 222, a check is made to determine is a new CBRNE trigger event has occurred or if event update information has been received from a first responder or a dispatch center. If not, as depicted by the negative branch from decision block 222, the DSS waits for a new alarm report event or event update. If a new alarm report or event update is received, as depicted by the positive branch from decision block 222, flow returns to block 206.

It will be apparent to those of ordinary skill in the art that the order of some of the operations in FIG. 2 may be changed. For example, the interface with the first responder can be activated at various points in the event processing.

FIG. 3 is a flow chart of a method for processing CBRNE trigger event data consistent with certain embodiments. Following start block 302 in FIG. 3, the decision support system (DSS) parses the alarm report at block 304 and looks for keywords in the data. The alarm report also includes the name of the CBRNE agent detected by the triggering sensor. A keyword usage list for the appropriate sensor type may be retrieved from a local or remote database. A keyword list is created and the CBRNE agent name from the CBRNE event record is added to the keyword list. At block 306 a computer aided dispatch (CAD) query is formed using the sensor type, location information, agent name and the identified keywords. At block 308 a CAD query is submitted. Optionally a guard timer may be started. At block 310 the

response to the CAD query is received and the guard timer is stopped. The guard timer is used to limit the amount of time spent waiting for a response from the CAD system. For example, the query may be terminated if the timer exceeds a specified time limit. The CAD response is added to the CBRNE event record at block 312. The CAD response may include, for example, geographic information system (GIS) location data, automatic vehicle location (AVL) data for vehicle identification and location, and a list of local hospitals. At block 314 the NOAA (or other source of local weather information) is queried for local weather information and the response is added to the CBRNE event record. At each stage the stored CBRNE event record is updated. The keyword list is used to retrieve contact information from a local or remote database at block 316. The appropriate contact information may be identified using the keyword list. At block 318 a default contact list is combined with the keyword-matched contact list to create the output contact list. The CBRNE event processing is completed at block 320.

FIG. 4 is a flow chart of a method for providing a first responder interface consistent with certain embodiments. Following start block 402 in FIG. 4, the decision support system (DSS) receives a connection request from a first responder (who has been dispatched to the site of the event that triggered the alarm). At block 406, the DSS sends an authentication request to the first responder. At block 408 the DSS receives a response to the authentication request from the first responder. The response is checked at decision block 410. If the first responder is not authenticated, as depicted by the negative branch from decision block 410, the process terminates at block 412 and the first responder is not provided with an interface. If the first responder is authenticated, as depicted by the positive branch from decision block

410, the first responder is informed at block 414 that the authentication process was successful. At this point, the first responder is connected with the DSS and may download and upload information from the DSS regarding the CBRNE event. For example, the DSS receives event information from the first responder at block 416, and at block 418 the DSS acknowledges receipt of the information. The DSS event record is updated using the new information at block 420. At block 422 the user is provided with an interface to the DSS. This interface may allow the first responder to browse historical data and current CBNRE event record information. The connection process is complete, as indicated by the termination block 424. The connection may remain in place until the first responder disconnects or a time-out occurs, for example.

Those skilled in the art will appreciate that the program steps and associated data used to implement the embodiments described above can be implemented using disc storage as well as other forms of storage, such as, for example, Read Only Memory (ROM) devices, Random Access Memory (RAM) devices, optical storage elements, magnetic storage elements, magneto-optical storage elements, flash memory and/or other equivalent storage technologies without departing from the present invention. Such alternative storage devices should be considered equivalents.

The present invention, as described in embodiments herein, is implemented using a programmed processor executing programming instructions that are broadly described above in flow chart form that can be stored on any suitable electronic storage medium. However, those skilled in the art will appreciate that the processes described above can be implemented in any number of variations and in many

suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A decision support system for generating, in response to a sensor alarm triggered by an event, a contact list of members from a plurality of agencies for a media share group, the decision support system comprising:
a first input operable to receive a sensor alarm report from a sensor data collector;
an interface operable to connect to a plurality of data sources;
a processor operable to:
process the sensor alarm report;
access at least one of the plurality of data sources, dependent upon the sensor alarm report, to obtain accessed data; and
generate a contact list dependent upon the accessed data; and
an output operable to output the contact list to a media share controller.

2. A decision support system in accordance with claim 1, further comprising a persistent data store operable to store an event record, wherein the processor is further operable to generate the event report dependent upon the sensor alarm report and the accessed data, the decision support system.

3. A decision support system in accordance with claim 1, further comprising an interface to a camera steering video capture (CSVC) server, wherein the processor is further operable to establish, via the CSVC server, a connection to a camera in proximity to the location of the event.

4. A decision support system in accordance with claim 1, further comprising a user interface to a responder dispatch center.

5. A decision support system in accordance with claim 1, further comprising a user interface to a first responder.

6. A decision support system in accordance with claim 1, wherein the plurality of data sources include a data source selected from a group of data source consisting of a Computer Aided Dispatch (CAD) center, a communication device of a first responder in proximity to the location of the event, a responder dispatch center, a government agency database, a private database and a medical facility.

7. A decision support system in accordance with claim 1, further comprising a video share controller operable to receive the contact list and to couple video signals between members of the contact list.

8. A decision support system in accordance with claim 1, further comprising a sensor data collector operable to receive and verify signals from a plurality of sensors.

9. A method for a decision support system to generate, in response to a sensor alarm triggered by an event, a contact list of members from a plurality of agencies for a media share group, the method comprising:
receiving a sensor alarm report from a sensor data controller;
processing the sensor alarm report;
accessing at least one data source of a plurality of data sources, dependent upon the sensor alarm report, to obtain accessed data;
generating a contact list dependent upon the accessed data; and
outputting the contact list to a media share controller.

10. A method in accordance with claim 9, further comprising:
generating an alarm to a dispatch center; and
servicing a user interface with the dispatch center.

11. A method in accordance with claim 9, further comprising:
selecting a video camera in proximity to the location of the event dependent upon location information in the sensor alarm report; and
connecting to the video camera via a camera steering video capture (CSVC) server.

12. A method in accordance with claim 9, further comprising:
generating an event record dependent upon the sensor alarm report and the accessed data; and
storing the event record in a persistent data store.

13. A method in accordance with claim 12, further comprising:
generating a user interface with a communication device of a first responder in proximity to the location of the event;
receiving event update information from the communication device; and
updating the event record dependent upon the event update information.

14. A method in accordance with claim 12, further comprising:
determining if the first responder is authenticated by the decision support system; and
allowing the first responder to access at least one of the plurality of data sources if the first responder is authenticated.

15. A method in accordance with claim 9, wherein the event is an event selected from the group of events consisting of a chemical event, a biological event, a radiological event, a nuclear event and an explosive event.

16. A method in accordance with claim 9, wherein accessing at least one data source of the plurality of data sources comprises accessing the at least one data source via a network.

17. A method in accordance with claim 9, wherein processing the sensor alarm report comprises:
retrieving keywords and event location information from the sensor alarm report;
generating a computer aided dispatch center query using the keywords and the event location information;
querying the computer aided dispatch center;
receiving a response to the query from the computer aided dispatch center; and
updating an event record dependent upon the response to the query.

18. A method in accordance with claim 17, further comprising:
accessing a contact database dependent upon the keywords to retrieve a first contact list; and
combining the first contact list and a default contact list to form the output contact list for the media share controller.

19. A method in accordance with claim 9, wherein processing the sensor alarm report comprises:
retrieving event location information from the sensor alarm report; and
accessing a weather database dependent upon the event location information to obtain local weather information.
